(19) United States
(12) Patent Application Publication
(10) Pub. No.: US 2008/0297438 A1
(43) Pub. Date: Dec. 4, 2008

(54) DIGITAL PHOTO FRAME

(75) Inventor: Tsung-Kai LIN, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/111,713

(22) Filed: Apr. 29, 2008

(30) Foreign Application Priority Data
Jun. 1, 2007 (TW) 096119867

(51) Int. Cl. G09G 3/00

(52) U.S. Cl. 345/30

(57) ABSTRACT

A digital photo frame includes a body and a stand. The body has a first combining portion, and the stand has a second combining portion. The first combining portion and the second combining portion are combined by magnetic attraction.

### CROSS REFERENCE TO RELATED APPLICATIONS

This Non-provisional application claims priority under 35 U.S.C. §119(a) on Patent Application No(s). 096119867 filed in Taiwan, Republic of China on Jun. 1, 2007, the entire contents of which are hereby incorporated by reference.

### BACKGROUND OF THE INVENTION

1. Field of Invention

The invention relates to a digital photo frame and, more particularly, to a digital photo frame whose body and stand are fixed by magnetic attraction.

2. Related Art

Along with the development of digital information, a digital photo frame is used to display or store photos and pictures popularly.

As shown in FIG. 1, a digital photo frame 10 on the market includes a body 12, a stand 14 and a pivot 16. The stand 14 is fixed on the body 12 via the pivot 16 to support the body 12, and then the body 12 can stand on a table top. The photos are placed in the body 12.

For the conventional design, when not using the digital photo frame 10, users cannot randomly detach and remove the stand 14. Therefore, it is inconvenient to pack up the digital photo frame 10. When the stand 14 is impacted by external force, it is easily damaged.

To solve the problem of the conventional digital photo frame, how to provide a digital photo frame whose stand can be randomly detached, removed, conveniently used and does not occupy space is an important subject.

### SUMMARY OF THE INVENTION

The objective of the invention is to provide a digital photo frame, and the stand of the digital photo frame can be randomly detached and removed to allow a user to conveniently use or pack.

To achieve the above objective, the invention provides a digital photo frame including a body and a stand. The body has a first combining portion, and the stand has a second combining portion. The second combining portion is detachably combined with the first combining portion, and magnetic attraction exists between the first combining portion and the second combining portion.

From the above, in the invention, a magnetism theory is used to solve the problem that a fixed stand cannot be randomly detached, removed, and occupies space in the conventional technology. Compared with the conventional technology, one of the body and stand of the digital photo frame of the invention is provided with a magnetic element, and the other is provided with a magnetic conductor, and even one of the body and stand is made of magnetic conductivity material, or both the body and the stand are provided with magnetic elements attracted by each other to allow the body and the stand to be closely combined via magnetic attraction. Then, a digital photo frame which can be easily detached, removed and conveniently brought is formed.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing the structure of a conventional digital photo frame;

FIG. 2 and FIG. 3 are exploded diagrams showing part of a digital photo frame according to a preferred embodiment of the invention;

FIG. 4 to FIG. 6 are schematic diagrams showing other implementing modes of a digital photo frame of a preferred embodiment of the invention;

FIG. 7 is a mechanics diagram showing a digital photo frame according to a preferred embodiment of the invention; and

FIG. 8 and FIG. 9 are schematic diagrams showing a group of implementing modes of a digital photo frame placed on a table top according to preferred embodiments of the invention.

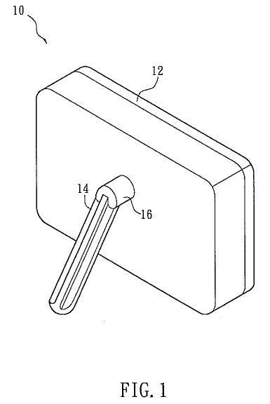

### DETAILED DESCRIPTION OF THE INVENTION

The present invention will be apparent from the following detailed description, which proceeds with reference to the accompanying drawings, wherein the same references relate to the same elements.

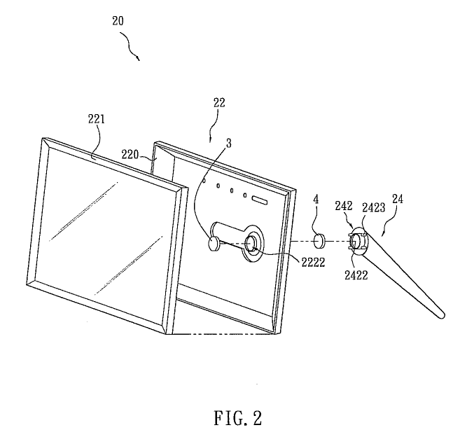

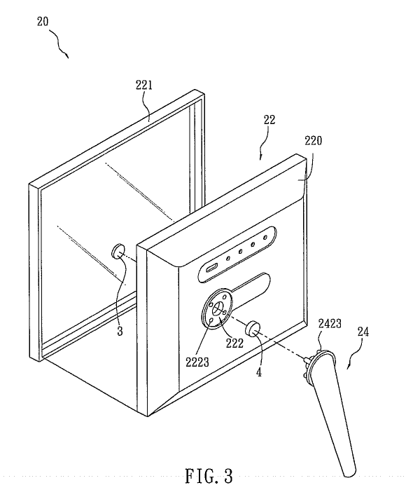

As shown in FIG. 2 and FIG. 3, a digital photo frame 20 of a preferred embodiment of the invention mostly includes a body 22 and a stand 24. The body 22 consists of a front cover 221 and a back cover 220. The front cover 221 and the back cover 220 can be combined with each other in a locking mode or a fastening mode.

The stand 24 of the embodiment can be shaft-shaped. When the stand 24 and the body 22 are combined with each other, an angle is formed between them. The stand 24 can be used to support the body 22 to stand on a surface such as a table top. The shape and implementing modes of the stand 24 can be adjusted according to actual conditions.

As shown in FIG. 2 and FIG. 3, the body 22 of the embodiment has a first combining portion 222, and the first combining portion 222 is located on the back cover 220 (as shown in FIG. 3). As shown in FIG. 2, the stand 24 has a second combining portion 242, and the first combining portion 222 and the second combining portion 242 are combined via magnetic attraction. The first combining portion 222 is recessed, and the second combining portion 242 is protrudent to cooperate with the first combining portion 222.

As shown in FIG. 2, in the embodiment, the first combining portion 222 has a first holding space 2222, and the second combining portion 242 has a second holding space 2422. The first holding space 2222 can hold a magnetic element 3, and the second holding space 2422 can hold a magnetic conductor 4. The magnetic element 3 and the magnetic conductor 4 can be fixed to the first holding space 2222 and the second holding space 2422, respectively, in a pasting mode or an embedding mode.

Herein, the magnetic element 3 may be magnetic iron, a magnet or electromagnet with magnetic force, and the material of the magnetic conductor 4 may be iron, tin-coated steel or galvanized steel which can be attracted by magnetic force.

As shown in FIG. 2 and FIG. 3, at least a first positioning element 2223 may be disposed at the first combining portion 222 of the embodiment, and at least a second positioning element 2423 may be disposed at the second combining portion 242. When positions of the first positioning element 2223 and the second positioning element 2423 are corresponding to each other, the second combining portion 242 can be combined with the first combining portion 222. That is, when the first positioning element 2223 is a recess, the second positioning element 2423 is a protrudent block, or when the first positioning element 2223 is a protrudent block, the second positioning element 2423 is a recess (not shown).

As shown in FIG. 2 and FIG. 3, the second positioning element 2423 can be disposed at the periphery of the second holding space 2422, and the first positioning element 2223 is disposed at a position corresponding to the position of the second positioning element 2423. The positions of the first positioning element 2223 and the second positioning element 2423 can be adjusted according to actual requirements.

From the above, when combining the stand 24 with the body 22, a user can make the first combining portion 222 face the second combining portion 242 and then fasten the first positioning element 2223 to the second positioning element 2423. At that moment, the magnetic element 3 in the first holding space 2222 and the magnetic conductor 4 in the second holding space 2422 are attracted by each other. As a result, the body 22 and the stand 24 can be closely combined with each other to form the digital photo frame 20. The body 22 can stand on a surface such as a table top via the stand 24.

In the embodiment, the magnetic element 3 and the magnetic conductor 4 are used to allow the body 22 and the stand 24 to attract each other, so the body 22 or the stand 24 may be made of plastic or other material which cannot be attracted by magnetic force.

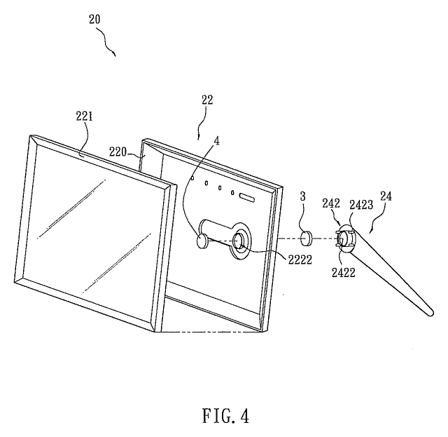

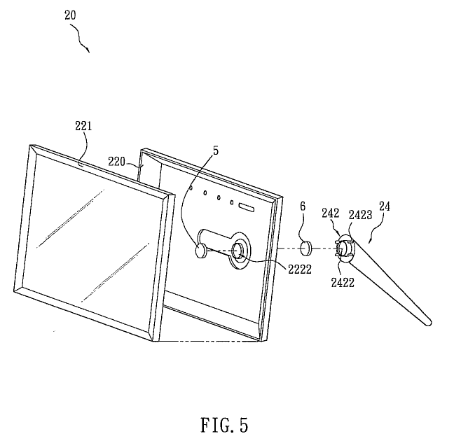

As shown in FIG. 4, the magnetic conductor 4 may also be held in the first holding space 2222, and the magnetic element 3 may be held in the second holding space 2422. As shown in FIG. 5, a first magnetic element 5 may be held in the first holding space 2222, a second magnetic element 6 attracting the first magnetic element 5 is held in the second holding space 2422.

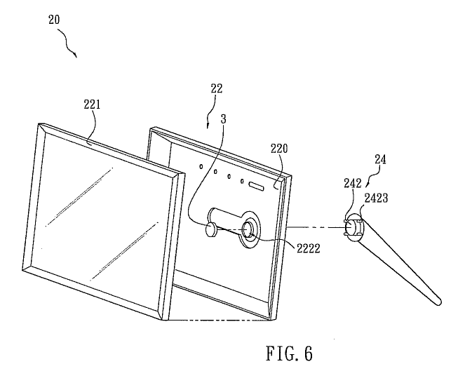

As shown in FIG. 6, when the magnetic element 3 is disposed at the first combining portion 222, the material of the second combining portion 242 may be magnetic conductivity material, and it's not necessary to dispose other magnetic conductor. When the material of the first combining portion 222 is magnetic conductivity material, the magnetic element 3 (not shown) is disposed at the second combining portion 242. The first combining portion 222 and the second combining portion 242 can be combined via the magnetic attraction in the above modes.

To make features of the embodiment to be further clear, the digital photo frame 20 is illustrated with a mechanics diagram.

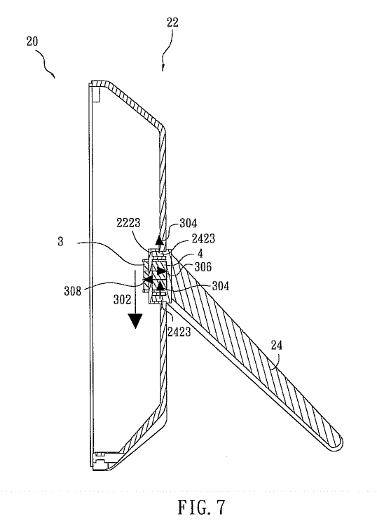

As shown in FIG. 7, in the embodiment, the body 22 has a downward gravity 302 in the perpendicular direction. A plurality of first position elements 2223 and a plurality of second positioning elements 2423 are used to provide upward supporting force 304. The supporting force 304 balances off the gravity 302 to make the digital photo frame 20 get balance in the perpendicular direction.

In the embodiment, the number of the first positioning elements 2223 or the second positioning elements 2423 is preferred to be four. Positions of the first positioning elements 2223 or the second positioning elements 2423 are opposite in pairs, and the angle between two adjacent first positioning elements 2223 or two adjacent second positioning elements 2423 is π/2 radian.

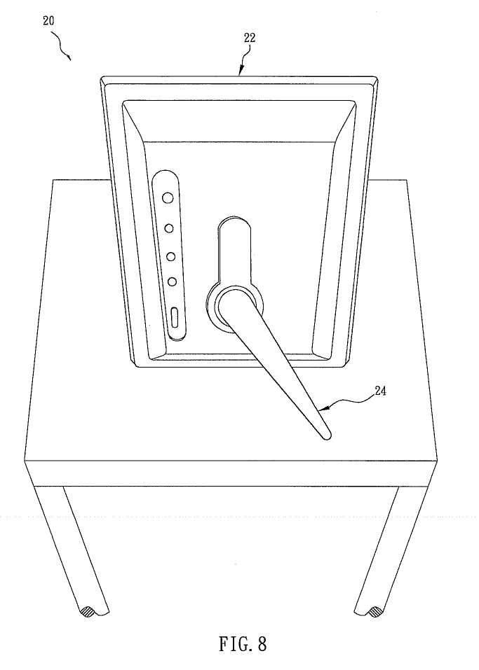

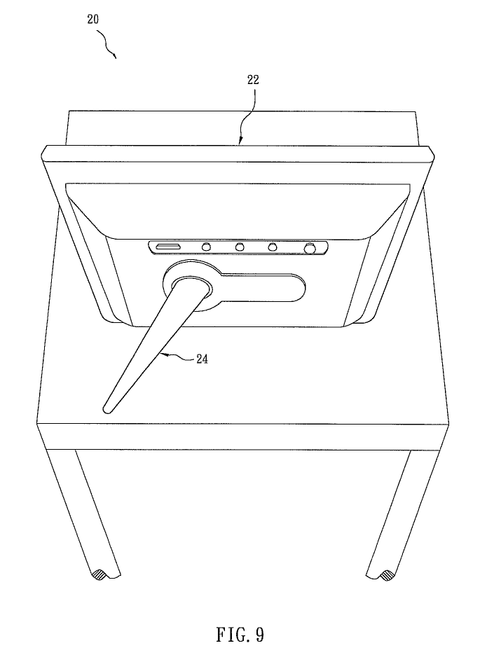

Via the above design, no matter the body 22 is placed on a surface with a short edge (as shown in FIG. 8) or a long edge (as shown in FIG. 9), it can steadily stand on the surface.

As shown in FIG. 7, the magnetic attraction 306 and 308 between the first combining portion 222 of the body 22 and the second combining portion 242 of the stand 24 makes the digital photo frame 20 also get balance in the horizontal direction.

If the first combining portion 222 and the second combining portion 242 are polygonally recessed and polygonally protrudent, respectively, the digital photo frame 20 can also obtain the same function described in the above content without using the positioning elements.

The body 22 further has a display module, a storage module, a processing module and an audio broadcast module (not shown), etc. The structure of the body 22 and components can be adjusted according to actual requirements, and they are not limited by the above embodiments.

To sum up, in the invention, a magnetism theory is used to solve the problem that a fixed stand cannot be randomly detached, removed, and occupies space in the conventional technology. Compared with the conventional technology, one of the body and stand of the digital photo frame of the invention is provided with a magnetic element, and the other is provided with a magnetic conductor, and even one of the body and stand is made of magnetic conductivity material, or both the body and the stand are provided with magnetic elements attracted by each other to allow the body and the stand to be closely combined via magnetic attraction. Then, a digital photo frame which can be easily detached, removed and conveniently brought is formed.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A digital photo frame comprising:
a body having a first combining portion; and
a stand having a second combining portion,
wherein the second combining portion is detachably combined with the first combining portion, and magnetic attraction exists between the first combining portion and the second combining portion.

2. The digital photo frame according to claim 1, wherein the first combining portion is recessed, and the second combining portion is protrudent to cooperate with the first combining portion.

3. The digital photo frame according to claim 1, wherein the first combining portion has a first holding space, and the second combining portion has a second holding space.

4. The digital photo frame according to claim 3, when a magnetic element is disposed at the first holding space, a magnetic conductor is disposed at the second holding space; when a magnetic conductor is disposed at the first holding space, a magnetic element is disposed at the second holding space.

5. The digital photo frame according to claim 3, wherein a first magnetic element is disposed at the first holding space, a second magnetic element is disposed at the second holding space, and the first magnetic element and the second magnetic element generate the magnetic attraction.

6. The digital photo frame according to claim 1, when a magnetic element is disposed at the first combining portion, the material of the second combining portion is magnetic conductivity material; when the material of the first combining portion is magnetic conductivity material, a magnetic element is disposed at the second combining portion.

7. The digital photo frame according to claim 4, wherein the magnetic element is magnetic iron, a magnet or electromagnet.

8. The digital photo frame according to claim 4, wherein the material of the magnetic conductor is iron, tin-coated steel or galvanized steel.

9. The digital photo frame according to claim 1, wherein at least a first positioning element is disposed at the first combining portion, at least a second positioning element is disposed at the second combining portion, and when the position of the first positioning element corresponds to the position of the second positioning element, the second combining portion can be combined with the first combining portion.

10. The digital photo frame according to claim 9, when the first positioning element is a protrudent block, the second positioning element is a recess for cooperating with the protrudent block, or when the first positioning element is a recess, the second positioning element is a protrudent block for cooperating with the recess.

11. The digital photo frame according to claim 1, wherein an angle is formed between the body and the stand.
